(19) United States
(12) Patent Application Publication
(10) Pub. No.: US 2015/0263523 A1
(43) Pub. Date: Sep. 17, 2015

(54) ENERGY STORAGE LOW DISPATCHABILITY POWER SOURCE

(71) Applicant: MADA Energie LLC, New York, NY (US)

(72) Inventor: ARNOLD J. GOLDMAN, JERUSALEM (IL)

(21) Appl. No.: 14/604,280

(22) Filed: Jan. 23, 2015

Related U.S. Application Data
(60) Provisional application No. 61/930,665, filed on Jan. 23, 2014.

(51) Int. Cl. H02J 3/38; H02J 7/00; H02J 7/35

(52) U.S. Cl. CPC H02J 3/382; H02J 7/35; H02J 7/0068; H02J 3/383; H02J 3/386

(57) ABSTRACT

An energy storage facility comprising at least one energy storage device and one renewable energy generating device is disclosed. The energy storage device can operate in a few modes of operation, consisting of at least a charging cycle and a discharging cycle. During one period of the charging cycle, energy is consumed by and stored within the energy storage device, and during a second period of discharging, energy from the storage device is dispatched to the grid. The total amount of energy consumed by the storage device is larger than the total amount of energy dispatched from the storage device. The total amount of energy dispatched to the electrical grid from both the storage device and the renewable energy generating device does not exceed the total amount of energy drawn down from the grid.

### CROSS-REFERENCE TO RELATED APPLICATIONS

The present application claims the benefit of U.S. Provisional Application No. 61/930,665, filed Jan. 23, 2014, which is hereby incorporated by reference herein in its entirety.

### FIELD AND BACKGROUND

Embodiments relate generally to the field of electrical energy and power, and more specifically to managing mismatch between available energy capacity and demand. Energy storage, and more specifically large scale electrical energy storage, is useful for renewable energy sources because of low dispatchability. Dispatchability in power generation refers to source's ability to dispatch power at the request of a demanding sink, for example, a power grid operator. Power generators that can be turned off or whose output can be modulated can adjust their output to track fluctuations in demand. Many renewable sources deliver energy based on capacity and cannot track demand very well. When combined with storage, this problem is mitigated.

During the process of evaluating the different storage systems there may be many different parameters involved. For example, one of these parameters may be the difference in the total amount of energy that the storage facility (or “energy storage system”) draws down from the electrical grid, versus the total amount of electrical energy that the energy storage system dispatches back to the electrical grid. This parameter of the storage system may become more important with dependence on the source of energy that is being stored within the storage system. In specific regions (e.g., California) there may be a growing desire for renewable energy sources for various reasons, and one such reason may be associated with meeting different known grid regulations.

Many of the storage systems known may operate in a few modes of operation whereas one mode of operation may be charging mode. Another mode of operation may be discharging mode. During the period of time when the system is operating in charging mode electrical energy is drawn down from the grid and is either stored or converted to some other form of energy that may be stored. During a second period of time the stored electricity or energy may be extracted from the storage system and may be dispatched back onto the grid as electricity. For many different reasons, the total amount of energy that is drawn down from the electrical grid may not equal the total amount of energy that the grid will eventually receive from the energy storage system. For example, the total amount of energy that the grid receives back from the energy storage system may be smaller than the amount of capacity that was drawn down from the grid during the charging period of the storage system.

### SUMMARY

In one or more embodiments, an energy storage facility comprises at least one energy storage device and one renewable energy generating device. The energy storage device can operate in a few modes of operation, consisting of at least a charging cycle and a discharging cycle. During one period of the charging cycle, energy is consumed by and stored within the energy storage device, and during a second period of discharging, energy from the storage device is dispatched to the grid. The total amount of energy consumed by the storage device is larger than the total amount of energy dispatched from the storage device. The total amount of energy dispatched to the electrical grid from both the storage device and the renewable energy generating device does not exceed the total amount of energy drawn down from the grid.

In one or more embodiments, a system for augmented energy storage/dispatch includes a Liquid Air Energy Storage (LAES) unit and a LAES external high temperature storage unit. The LAES is coupled to an electric power consumer and an electric power source to draw down and store excess electric capacity of the electric power source and dispatch stored capacity to the electric power consumer. The LAES is also coupled to and augmented by a low dispatchability electric power source to store electric capacity of the low dispatchability electric power source. The LAES is further coupled to and augmented by a low dispatchability thermal energy source. The LAES external high temperature storage unit is coupled to the low dispatchability electric power source and the electric power source to store electric energy of the low dispatchability electric power source and/or the electric power source as thermal energy. The LAES external high temperature storage unit also being coupled to the low dispatchability thermal energy source to store thermal energy from the low dispatchability thermal energy source as thermal enegery. The LAES external high temperature storage unit further coupled to the LAES to provide stored thermal energy to the LAES during a discharge mode of the LAES to increase the output capacity of the LAES when dispatching energy to the electric power consumer.

In one or more embodiments, a method for augmented energy storage includes detecting excess electric energy on a grid or receiving a request to store excess electric energy on the grid. An energy storage system is configured, responsive to the detecting or receiving, to store the excess electric energy and an amount of excess electric energy from the grid is stored. Renewable energy is received from a renewable energy source and, responsive to the receiving renewable energy, the energy storage system is configured to store the renewable energy and an amount of renewable energy from the renewable energy source is stored. An amount of electric energy can then be dispatched to the electric grid, the stored renewable energy being used to generate a portion of the amount of energy dispatched to the grid to reduce the difference between the amount of excess energy stored from the grid and the amount of electric energy dispatched to the grid.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements. As used herein, various embodiments can mean one, some, or all.

FIG. 1 illustrates a Liquid Air Energy Storage (LAES) apparatus, in accordance with an embodiment.

FIG. 2 illustrates a LAES system with solar and/or wind capacity augmentation, in accordance with an embodiment.

FIG. 3 illustrates a LAES system with low dispatchability electric and/or thermal augmentation, in accordance with an embodiment.

FIG. 4 illustrates a LAES system with low dispatchability electric and/or thermal augmentation, in accordance with an embodiment.

FIG. 5 illustrates an augmented LAES system, in accordance with an embodiment.

FIG. 6 illustrates a controller for a LAES system with low dispatchability electric and/or thermal augmentation, in accordance with an embodiment.

FIG. 7 illustrates a controller for a LAES system with solar and/or wind capacity augmentation, in accordance with an embodiment.

FIG. 8 illustrates a method for controlling a LAES system with low dispatchability electric and/or thermal augmentation, in accordance with an embodiment.

### DETAILED DESCRIPTION

Embodiments include one or more energy storage systems such as, for example, a Liquid Air Energy Storage (LAES) system. The LAES may be charged during one period of time and may be discharged during a second period of time. During the charging period, the LAES may convert electrical energy to thermal energy and liquid air, and store the thermal energy and liquid air for later use. During the discharging period, the LAES may convert the thermal energy and liquid air stored in the LAES to electrical energy.

In some embodiments, thermal energy stored in the LAES may have a range of temperatures. For example, the LAES may convert electrical energy to thermal energy at a range of high temperatures and a range of low temperatures. Different ranges of temperatures may be stored in suitable substances for a short or prolonged period of time as known to one who is skilled in the art. When the LAES is operating in charging mode (charging cycle), the LAES generates liquid air and stores the liquid air that has been generated. Generating liquid air may be achieved by assembling devices, apparatuses, flow directions or the like that working together may generate liquid air such as, for example, rotating equipment (e.g., compressors and/or motors). During periods of time that the LAES is configured to operate in the charging cycle, the LAES may draw down electrical energy (from any electrical energy source such as, for example, the electrical grid) and power a motor and/or a compressor (one or more). The compressor may trap and compress air from the environment into the LAES. The compressed air may rise in pressure and temperature. The high temperature in the air may be extracted from the air and stored in a thermal energy storage unit. Compressing the air and extracting the high temperature thermal energy from the air may be done once or more. The compressed air (air stream) may be further processed by compression and heat extraction processes in order to achieve liquefaction. Further processing of the air may involve directing the air through one or more heat exchangers and/or cold storage units in order to further reduce the temperature of the air stream. The air stream may be directed through an expander device (or other means or apparatuses) that may reduce the pressure and temperature of the air stream. The air stream at the outlet of the expander device may be liquefied. In some embodiments, a percentage of the air stream may be liquefied and the rest of the air stream may remain in a gaseous form. In such embodiments, the air which remained in a gas form may be directed through one or more heat exchangers, exchanging thermal energy with the incoming air stream compressed through the LAES, thus reducing the air stream's temperature prior to exiting the LAES. The air stream which has transformed to liquid may be stored in a liquid air storage unit. At the end of the charging process, the LAES may contain liquid air in a liquid air storage unit and high temperature (or relatively high temperature) thermal energy may be stored in high temperature thermal energy storage units.

The LAES may operate at a second period of time in discharge mode. In such a mode of operation, liquid air may be pumped through the LAES to generate electrical energy. For example, a liquid air pump may pump liquid air from the liquid air storage unit through the different thermal energy storage units of the LAES (or other thermal energy storage units, or thermal energy locations). During this process the liquid air may exchange high thermal energy that is stored in the storage units (or receive high thermal energy from different locations) and emit low thermal energy to the storage units that may be stored for later use (e.g., for use during the charging cycle as a means to reduce the temperature of the air stream). The liquid air, which has been pumped at desired pressures and received high temperature thermal energy, may be directed to drive one or more rotating equipment (e.g., a turbine) to generate electrical energy.

The amount of electrical energy that the LAES draws down from the grid may exceed the amount of electrical energy that the LAES is generating and dispatching to the electrical grid. The difference between the amount of energy drawn down from the grid by the LAES and the amount of energy dispatched to the grid by the LAES is the “energy gap” of the LAES. The energy gap of the LAES may be a limitation that would disqualify the LAES from being a chosen storage solution in a specific case or region.

Therefore, it may be desirable to minimize the energy gap of the LAES. In regions that are attempting to meet grid regulations related to needing energy from renewable sources, there may be an additional desire not to lose or to limit as much as possible the loss of renewable energy. If energy storage is needed, then the loss in energy may be a key factor during the decision making process as to what storage system is to be utilized.

In some embodiments, a LAES is augmented by at least one or more Photo Voltage (PV) apparatuses to, for example, reduce the energy gap of the LAES and/or reduce the loss of renewable energy. During the period when the sun is available and the PV apparatus is generating electrical energy, this electrical energy may be directed to more than one destination such as, for example, the electrical grid and/or the LAES. In such embodiments, the LAES may draw down the electrical output of the PV apparatus. During the period of time when the electrical output of the PV apparatus is drawn down by the LAES, the energy is converted to thermal energy and to liquid air as detailed above. During the discharge of the LAES, this added energy (of thermal energy and liquid air) can be added to the total amount of energy that has been generated via converting electrical energy from the grid. Such embodiments may therefore operate with a smaller energy gap between the charge and discharge cycles of the LAES. In some such embodiments, as the desire to reduce the size of the gap increases, the sizing of the PV apparatus may grow.

In some embodiments, a LAES is augmented by at least a LAES external high temperature storage unit and one or more concentrated thermal solar systems to, for example, reduce the energy gap of the LAES and/or reduce the loss of renewable energy. Whereas during the period that the sun radiation is available and suitable. The concentrated solar may operate to generate high temperature thermal energy. The high temperature thermal energy generated via the concentrated thermal solar may be stored. The high temperature thermal energy may be stored within a suitable material that may be located with a high temperature thermal energy storage vessel/s as known to one who is skilled in the art. The high temperature thermal energy stored within the high temperature thermal energy storage vessel/s may be utilized during the discharge cycle of the LAES. During the discharge cycle liquid air may be pumped from a liquid air storage vessel throughout the LAES. The liquid air may be vaporized throughout this process. The vaporized liquid air may be directed to the high temperature thermal energy storage vessel/s. High temperature thermal energy may be extracted from the material that may contain the high temperature thermal energy storage which may be stored within the high temperature thermal energy storage vessel/s. The vaporized liquid air exiting the high temperature thermal energy storage vessel/s may be directed to drive a turbine. Due to the increase in the temperature of the vapor, the turbine may generate electrical energy at a higher capacity. Higher capacity may result in decreasing the gap between the total amount of energy that is drawn down during the charging cycle and the total amount of energy that is dispatched during the discharging cycle.

In some embodiments, a LAES is augmented by at least a LAES external high temperature storage unit and one or more Photo Voltage (PV) apparatuses to, for example, reduce the energy gap of the LAES and/or reduce the loss of renewable energy. During the period when the sun is available and the PV apparatus is generating electrical energy, this electrical energy may be directed to more than one destination wherein one of the destinations may be the electrical grid. Another destination which the electrical output of the PV may be directed towards is the LAES. The LAES may draw down the electrical output of the PV apparatus. During the period of time when the electrical output of the PV is drawn down by the LAES it is directed to power heating coils. The thermal energy that is generated by the heating coils may be stored within a suitable material that may be contained with a suitable high temperature thermal energy storage vessel/s. During the discharge cycle liquid air may be pumped from a liquid air storage vessel throughout the LAES. The liquid air may be vaporized throughout this process. The vaporized liquid air may be directed to the high temperature thermal energy storage vessel/s. High temperature thermal energy may be extracted from the material that may contain the high temperature thermal energy storage which may be stored within the high temperature thermal energy storage vessel/s. The vaporized liquid air exiting the high temperature thermal energy storage vessel/s may be directed to drive a turbine. Due to the increase in the temperature of the vapor, the turbine may generate electrical energy at a higher capacity. The higher capacity may result in decreasing the gap between the total amount of energy that is drawn down during the charging cycle and the total amount of energy that is dispatched during the discharging cycle.

In some embodiments, a LAES is augmented by at least one or more wind farms to, for example, reduce the energy gap of the LAES and/or reduce the loss of renewable energy. In such embodiments, an electrical output generated from a wind farm may be directed to and consumed by the LAES. In such embodiments, the electrical output may be converted to high temperature thermal energy and/or liquid air, as detailed above.

In some embodiments, a LAES is augmented by at least a LAES external high temperature storage unit and one or more wind farms to, for example, reduce the energy gap of the LAES and/or reduce the loss of renewable energy. In such embodiments, the electrical output of the wind farm may be directed to power heating coils. Thermal energy generated by the heating coils can be stored in the LAES external high temperature storage unit, as described above.

According to an embodiment, a LAES is operated in conjunction with (i.e., augmented by) a PV system, a concentrated thermal solar system, and a wind farm. In various embodiments, a LAES is operated with any combination of: a PV system, a concentrated thermal solar system, and/or a wind farm.

Some embodiments are configured to ensure that the total amount of energy that is generated from one or more renewable energy sources and is dispatched onto the grid does not exceed the amount of energy that has been lost during the process of the charging and discharging. This configuration ensures that such embodiments are not to be classified as a generator, and thus the maximum efficiency of such embodiments (measured as energy from the grid verses energy to the grid) is 100%. As has been stated above, energy generated from the renewable energy device may be directed to charge the LAES and/or directed to the grid (DC/AC converter if needed). In the event that the energy is directed to the LAES, there will be a loss of energy due to the LAES's efficiency. In the event that the energy is directed to the grid, there may be no or limited efficiency loss (whereas the DC/AC conversion may contain efficiency loss). In some embodiments, the total amount of energy dispatched from the facility as a whole (i.e., energy from both the LAES and the renewable energy source) will not exceed the total amount of energy that has been drawn down by the LAES from the grid.

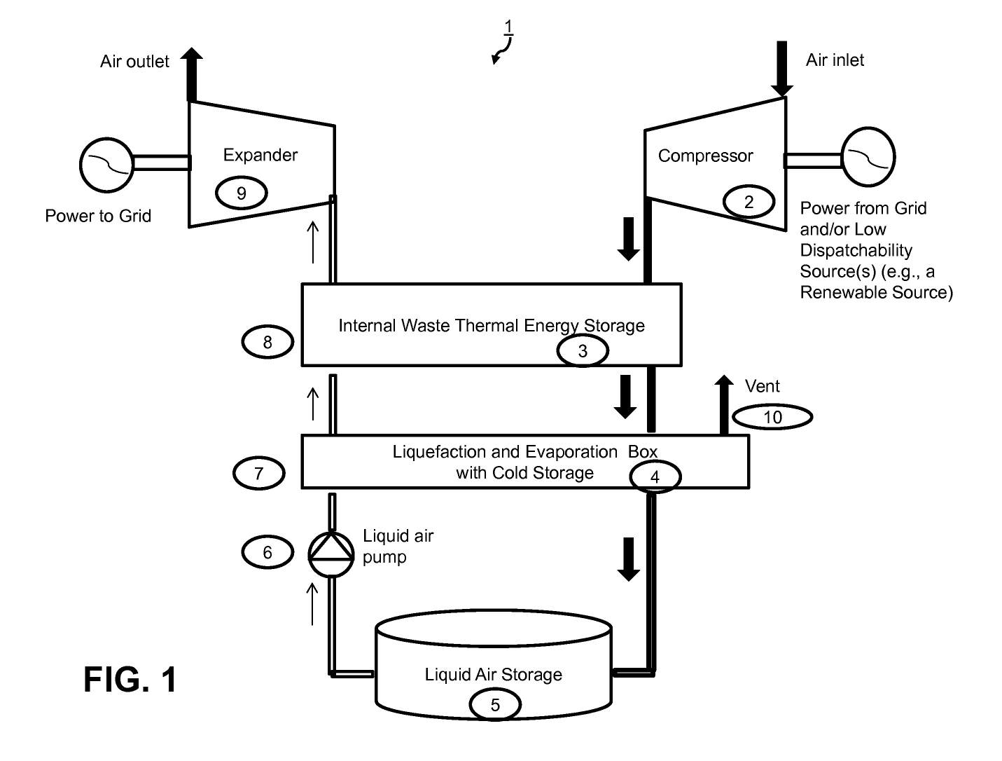

FIG. 1 illustrates a LAES apparatus (or LAES) 1, in accordance with an embodiment. LAES 1 may operate in a few modes of operation. In one mode of operation the LAES 1 may draw down electrical energy from any electrical source, convert the electrical energy to both high and low thermal energy temperatures (this mode will be referred to as the charging cycle). During a second period of time the LAES 1 may convert thermal energy stored in the LAES 1 to electrical energy that may be dispatched to the electrical grid.

By one embodiment a LAES 1 may operate in charging mode. During the charging mode electrical energy may be drawn down from any electrical energy source to power a compressor 2 (or compressors indicated by compressor 2). The compressor 2 may trap air from the environment into the LAES 1. The now compressed air's temperature and pressure may rise as a result of the compression. High thermal energy may be extracted from the air and stored in an internal waste thermal energy storage 3. The air stream may be directed to further processing in order to liquefy the air stream to liquid air. Further liquefaction may be a result of means and apparatuses such as directing the air stream through cold storage units, etc. The apparatuses such as cold storages units, expander device etc. may be located or associated with the liquefaction and evaporation box with cold storage 4. The air stream exiting the Liquefaction and evaporation box with cold storage 4 may be liquefied. Liquid air may then be stored in a liquid air storage 5. A percentage of the air stream may remain in a gaseous form, and the air stream which has remained in a gaseous form may be directed through the LAES in order to be utilized through the charging process. The air stream that has been redirected through the liquefaction and evaporation box with cold storage 4 may be vented out of the LAES.

The LAES apparatus 1 may operate in a discharge mode. A liquid air pump 6 may pump liquid air from the liquid air storage unit 5, through the LAES apparatus 1 at required pressure. The liquid air may be processed in the liquefaction and evaporation box with cold storage 7 (whereas the number change is indicative of the two modes of charge and discharge). During this process, the liquid air may exchange relatively low thermal energy temperature (relative to the thermal energy contained in the cold storage units) with relatively high thermal energy contained in substances with cold storage of liquefaction and evaporation box with cold storage 7. Relatively low thermal energy that has been extracted from the liquid air may be stored in the cold storages for use during the charging cycle. The pumped air stream exits the liquefaction and evaporation box with cold storage 7 and is directed to the internal waste thermal energy storage 8 (wherein the number change is indicative of the two modes of charge and discharge). In the internal waste thermal energy storage 8, the pumped liquid air stream (now in a gaseous form after evaporation) exchange thermal energy with the substances located within the storage units of the internal waste thermal energy storage 8. During this process, the air stream may exchange relatively low thermal energy temperature (relative to the thermal energy contained in the waste thermal energy storages units) with relatively high thermal energy contained in the substances of the internal waste thermal energy storage 8. Relatively low thermal energy that has been extracted from the liquid air may be stored in the waste thermal energy storage for use during the charging cycle. The air stream exiting the internal waste thermal energy storage 8 may be directed to drive an expander 9, which may generate electrical energy.

The electrical capacity that is being drawn down during the charge cycle may exceed the electrical capacity that is generated and dispatched during the discharge cycle. It may be the desirable to minimize the gap between the charge and discharge cycle.

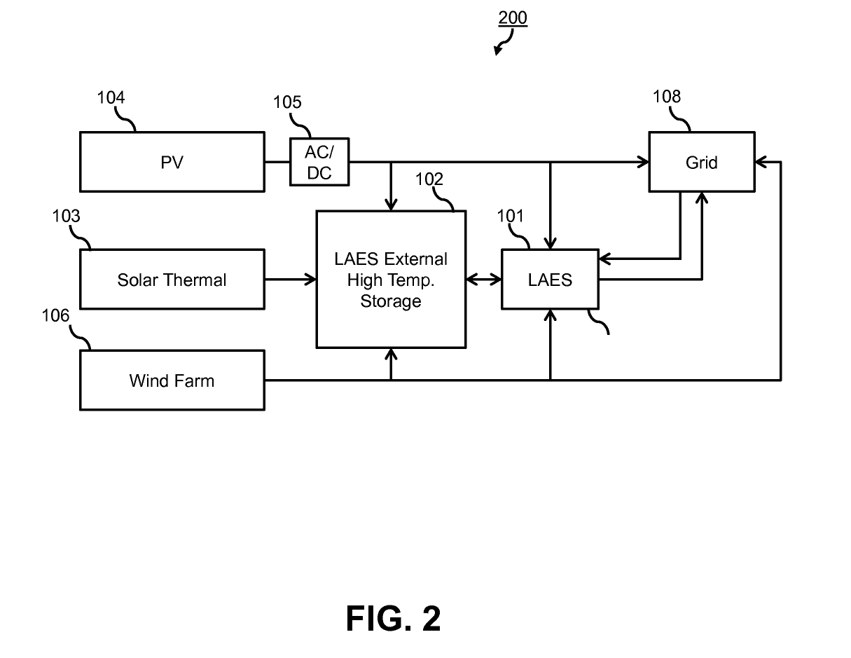

FIG. 2 illustrates a LAES system 200 with solar and/or wind capacity augmentation, in accordance with an embodiment. The LAES system 200 includes a LAES 101 in conjunction with one or more apparatuses wherein LAES 101 may operate with a PV apparatus 104, a solar thermal apparatus 103, and/or a wind turbine or turbines 106.

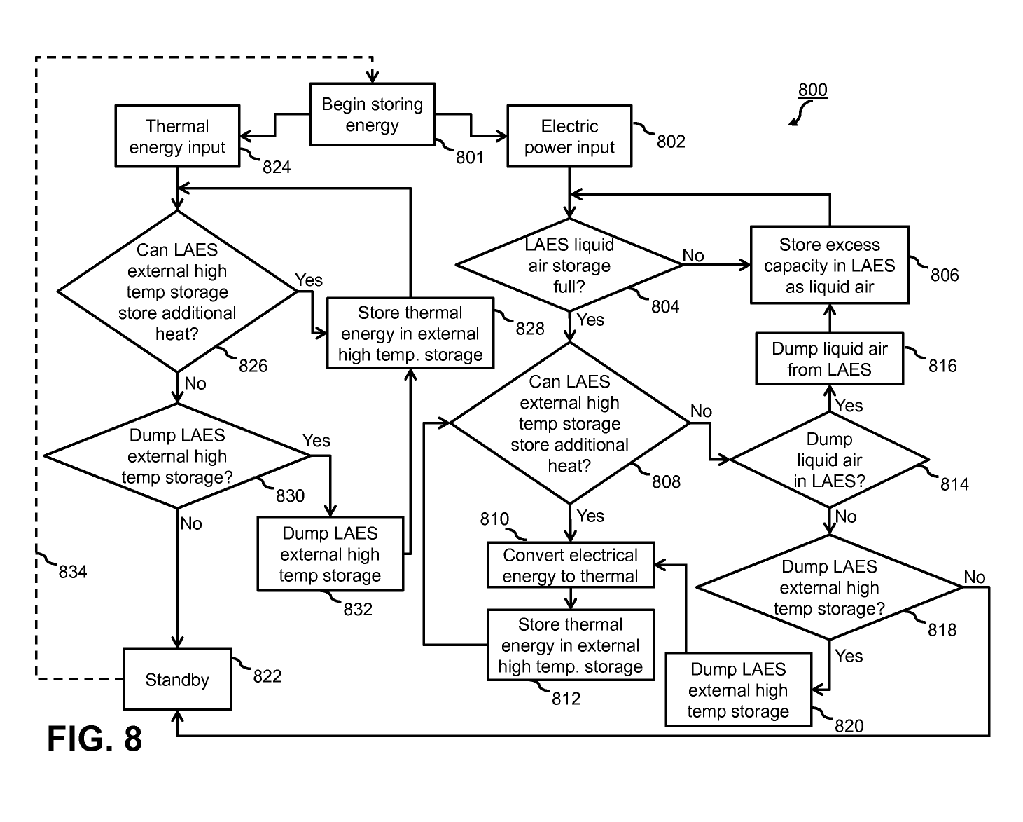

In some embodiments, LAES 101 is operating PV apparatus 104. PV apparatus 104 may dispatch electrical energy directly to the grid 108. Electrical output of PV apparatus 104 may be directed to an AC/DC 105 converter prior to being dispatched to the grid 108. The electrical output of the PV apparatus 104 may be directed and consumed by the LAES 101 as detailed above, and as shown, for example, in FIG. 8.

In some embodiments, the electrical output of the PV apparatus 104 may be converted to thermal energy and liquid air as detailed above, and as shown, for example, in FIG. 8. For example, the electrical output of the PV apparatus 104 may be directed to power heating coils (not shown). The high temperature generated by the heating coils may be stored in the external high temperature storage vessel/s unit 102. In such embodiments, during the discharge cycle of the LAES 101, high temperature stored within the external high temperature storage vessel/s unit 102 may be extracted prior to the vapor being directed to drive the expander of the LAES 101, such as expander 9 of FIG. 1.

In some embodiments, LAES 101 is augmented by solar thermal apparatus 103. In some such embodiments, high temperature thermal energy that is generated by the solar thermal apparatus 103 may be absorbed and stored in an external high temperature energy storage 102 associated with the LAES apparatus 101. The LAES apparatus 101 in conjunction with the external high temperature energy storage 102 may be discharged to generate electrical energy as stated above.

In some embodiments, LAES 101 is operating in conjunction with wind turbine(s) 106. In some such embodiments, when the electrical output of the wind turbine(s) 106 is directed to and consumed by the LAES 101, the electrical output may be converted to high temperature thermal energy and liquid air as detailed above. Additionally or alternatively, the electrical output of the wind turbine or turbines 106 may be directed to power heating coils (not shown). In such embodiments, the high temperature generated by the heating coils may be stored within a suitable material that is located in (or associated with) external high temperature energy storage 102. The system can determine whether to store electrical capacity of the wind turbine(s) 106 in the LAES directly or to convert the electrical capacity to thermal energy to be stored in the external high temperature energy storage 102 based on, for example, the remaining capacity of the LAES liquid air storage as shown, for example, in FIG. 8. During the LAES's 101 discharge cycle, high temperature thermal energy located within external high temperature energy storage 102 may be extracted prior to driving an expander of the LAES 101 such as the expander 9 of FIG. 1, as detailed above.

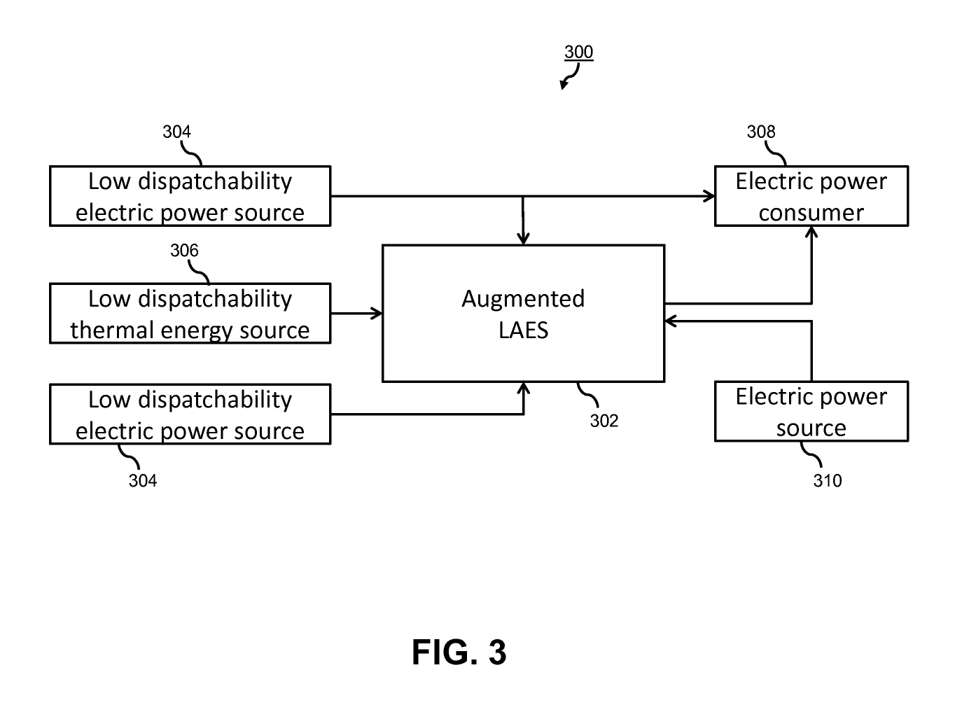

FIG. 3 illustrates a LAES system 300 with low dispatchability electric and/or thermal augmentation, in accordance with an embodiment. System 300 includes an augmented LAES 302, low dispatchability electric power sources 304, a low dispatchability thermal energy source 306, an electric power consumer 308, and an electric power source 310. Augmented LAES 302 can draw down and store electric power from electric power source 310, and dispatch stored energy to electric power consumer 308. To decrease the gap between the capacity drawn down by LAES 302 from source 310 and the capacity dispatched to consumer 308, LAES 302 can store electric capacity from low dispatchability electric power sources 304 and/or store thermal energy from low dispatchability thermal energy source 306. This stored energy from low dispatchability sources 304/306 can then be used by augmented LAES 302 when dispatching energy to electric power consumer 308 to reduce the capacity gap of the LAES 302. In some embodiments, low dispatchability sources 304/306 are renewable energy sources such as solar PV, concentrated thermal solar, and/or wind turbine(s). In some embodiments, electric power source 310 and electric power consumer 308 can be the electric grid as shown, for example, as grid 108 in FIG. 2.

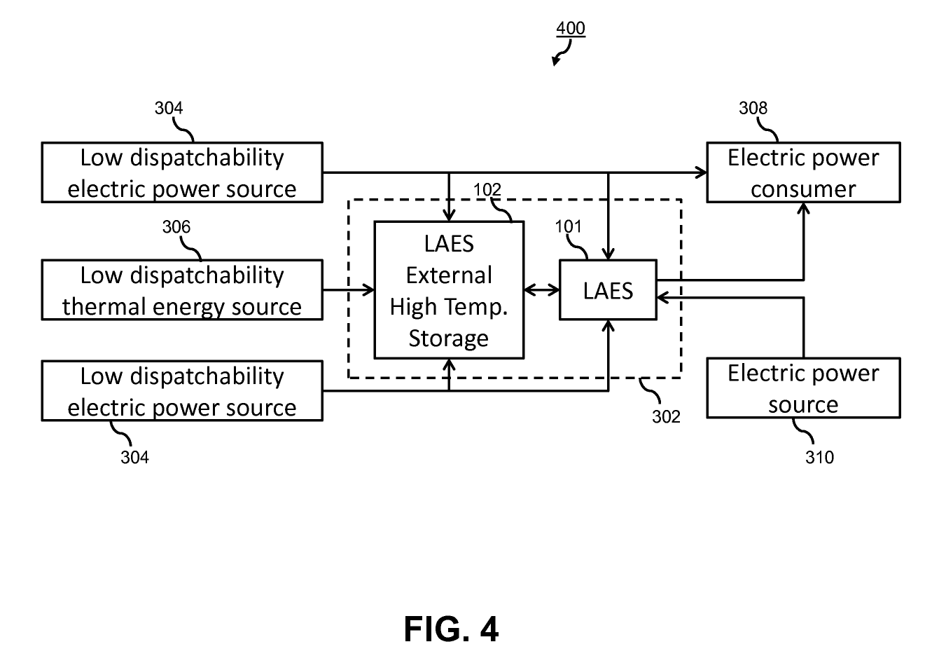

FIG. 4 illustrates a LAES system 400 with low dispatchability electric and/or thermal augmentation, in accordance with an embodiment. System 400 includes an augmented LAES 302, low dispatchability electric power sources 304, a low dispatchability thermal energy source 306, an electric power consumer 308, and an electric power source 310. Augmented LAES 302 can include LAES external high temperature storage unit 102 and LAES 101.

LAES 101 can draw down and store electric power from electric power source 310, as described above and/or as shown, for example, in FIG. 8. LAES 101 can be augmented with and store electrical energy from low dispatchability electric power sources 304 (e.g., solar electric such as, for example, PV 104 and/or wind farm/turbine(s) such as, for example, wind farm 106). LAES 101 can also be augmented with and store, using LAES external high temperature storage unit 102, thermal energy from low dispatchability thermal energy source 306 (e.g., solar thermal such as solar thermal 103). LAES 101/102 can store augmentation electric capacity and/or thermal energy as shown, for example, in FIG. 8. LAES 101 can then utilize the stored augmentation energy when dispatching stored energy to electric power consumer 308, thereby reducing the capacity gap of LAES 101, as described above.

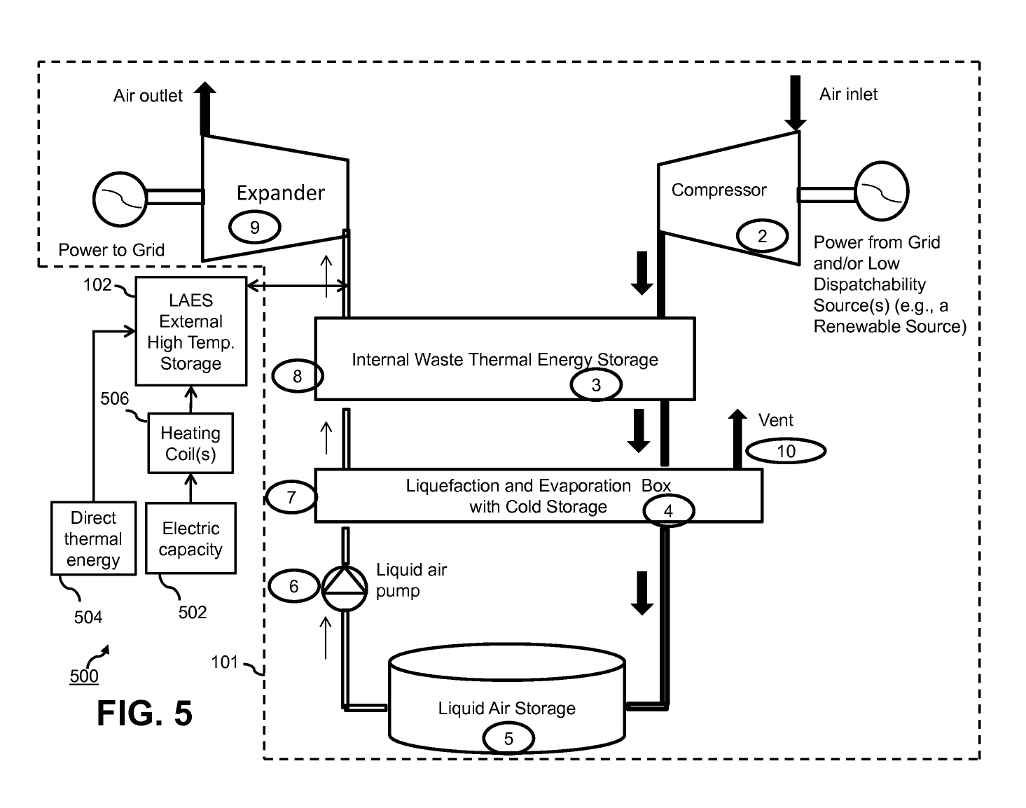

FIG. 5 illustrates an augmented LAES system 500, in accordance with an embodiment. Augmented LAES 500 includes LAES 101 and LAES external high temperature storage unit 102. Augmented LAES 500 can store electric energy using LAES 101 as described above and/or as shown, for example, in FIG. 1. Augmented LAES 500 can also store electric energy using LAES external high temperature storage unit 102 by directing the electric energy 502 to one or more heating coil(s) 506 to generate thermal energy which is then stored in LAES external high temperature storage unit 102. Augmented LAES 500 can also store thermal energy in LAES external high temperature storage unit 102.

Augmented LAES 500 can determine whether to use LAES 101 or LAES external high temperature storage unit 102 to store electric energy based on the source of the electric energy and/or the respective available storage capacity of LAES 101 and LAES external high temperature storage unit 102. For example, in some embodiments, augmented LAES 500 is configured to determine whether to store electric energy in LAES 101 or LAES external high temperature storage unit 102 based on the available storage capacity of LAES 101 or LAES external high temperature storage unit 102 as shown, for example, in FIG. 8. In some embodiments, augmented LAES 500 is configured to prioritize the storage of energy from low dispatchability sources (e.g., renewable energy sources). In some such embodiments, when there is no available storage capacity of either or both of LAES 101 or LAES external high temperature storage unit 102, augmented LAES 500 is configured to dump/release stored energy to enable additional energy from the low dispatchability sources to be stored as shown, for example, in FIG. 8.

In some embodiments, heating coil(s) 506 are located within LAES external high temperature storage unit 102.

In some embodiments, augmented LAES 500 is configured to ensure that the total amount of energy that is generated from one or more renewable sources and is dispatched onto the grid does not exceed the amount of energy that has been lost during the process of the charging and discharging LAES 101. This configuration ensures that such embodiments are not classified as a generator and therefore the maximum efficiency of such embodiments (measured as energy from the grid verses energy to the grid) is 100%.

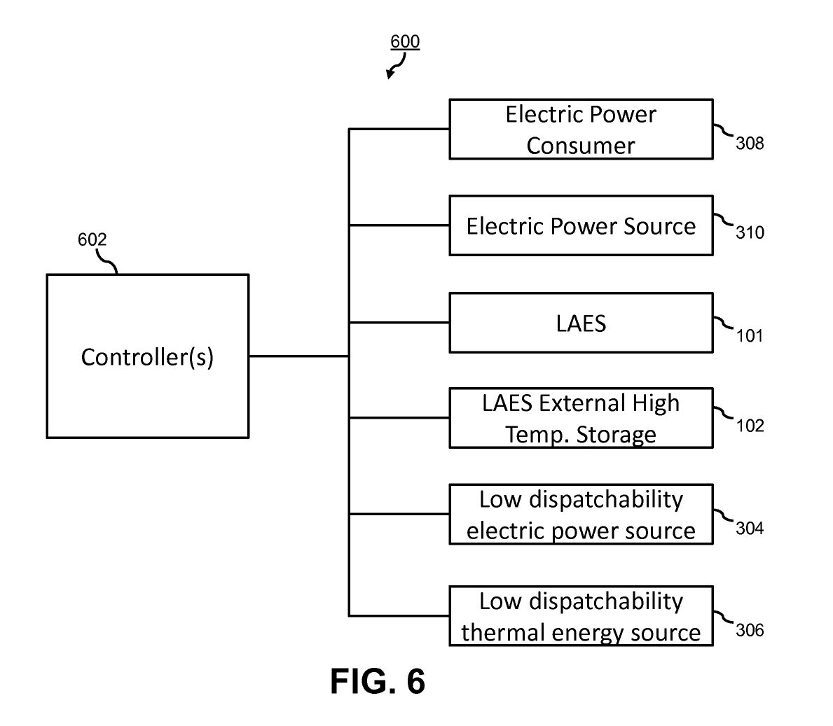

FIG. 6 illustrates controller(s) 602 for a LAES system 600 with low dispatchability electric and/or thermal augmentation, in accordance with an embodiment. System 600 includes one or more controller(s) 602, LAES 101, LAES external high temperature storage unit 102, low dispatchability electric power sources 304, low dispatchability thermal energy source 306, electric power consumer 308, and electric power source 310. Controller(s) 602 can control one or more of 101, 102, and 304-310 to perform energy storage/dispatch using LAES 101 with low dispatchability power source augmentation, as described hereinabove, and as shown, for example, in FIG. 8.

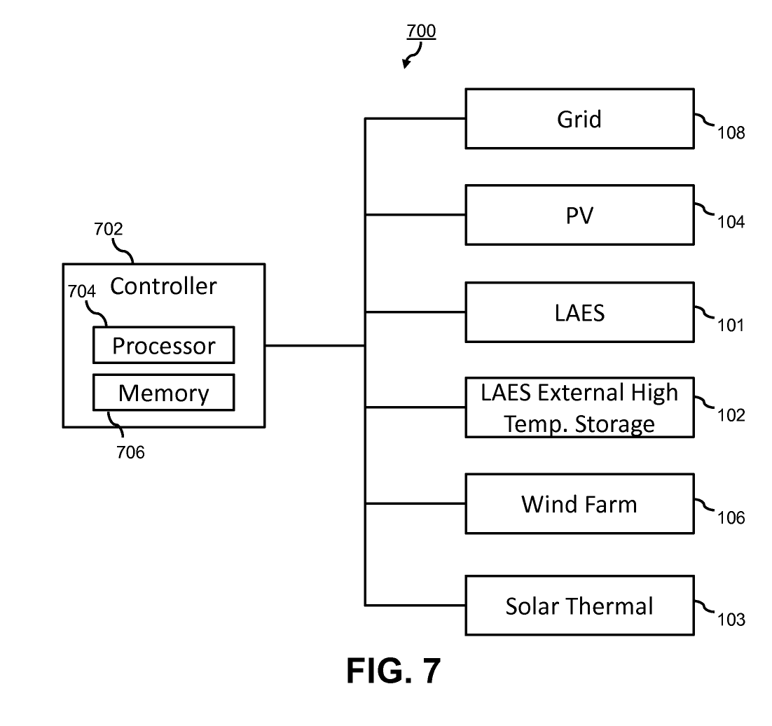

FIG. 7 illustrates a controller for a LAES system 700 with solar and/or wind capacity augmentation, in accordance with an embodiment. System 700 includes a controller 702, LAES 101, LAES external high temperature storage unit 102, grid 108, solar PV 104, wind farm 106, and solar thermal 103. Controller 702 includes a processor 704 and a memory 706, the memory storing instructions that when executed by the processor, cause the processor to control the operation of one or more of 101-108 to perform energy storage/dispatch using LAES 101 with solar and/or wind augmentation, as described hereinabove, and as shown, for example, in FIG. 8.

FIG. 8 illustrates a method 800 for controlling a LAES system with low dispatchability electric and/or thermal augmentation, in accordance with an embodiment. Method 800 begins at 801 and proceeds to 802 and/or 824.

At 802, electric capacity is determined to be available to be drawn down and stored. This can include, for example, detecting excess electric capacity on the grid (i.e., grid 108), a low dispatchability electric power source (i.e. low dispatchability electric power source 304, solar PV 104, and/or wind farm 106), or other electric power source. Additionally or alternatively, determining availability at 802 can include receiving a request to store excess electric capacity from, for example, the grid (i.e., grid 108), a low dispatchability electric power source (i.e. low dispatchability electric power source 304, solar PV 104, and/or wind farm 106), or other electric power source.

At 804, the system determines whether the LAES liquid air storage is full and if so proceeds to 808, and otherwise proceeds to 806.

At 806, the electric capacity is stored in the LAES as thermal energy and liquid air, as described above.

At 808, the system determines whether the LAES external high temp storage unit can store additional thermal energy, and if so proceeds 810, and otherwise proceeds 814.

At 810, the electric capacity is converted to thermal energy. For example, the electric capacity can be converted to thermal energy using a heat coil as describe above and as shown, for example, in FIG. 5.

At 812, the thermal energy generated at 810 is stored in the LAES external high temperature storage unit.

At 814, the system determines whether liquid air stored in the LAES liquid air storage unit can be dumped, and if so proceeds 816 to dump stored liquid air and then further proceeds to 806 to continue storing the electric capacity in the LAES.

At 818, the system determines if thermal energy can be dumped/released from the LAES eternal high temperature storage unit, and if so proceed to 820, and otherwise proceeds to 822 where the system enters standby.

At 824, thermal energy is determined to be available to be stored by the LAES external high temperature storage unit. This can include, for example, receiving thermal energy from a low dispatchability thermal energy source such as, for example, solar thermal 103.

At 826, the system determines whether the LAES external high temperature storage unit can store additional thermal energy, and if so proceeds to 828, and otherwise proceeds to 830.

At 828, the thermal energy is stored in the LAES external high temperature storage unit.

At 830, the system determines whether thermal energy stored in the LAES external high temperature storage unit can be released/dumped to enable the system to continue storing thermal energy, and if so proceeds to 832, and otherwise proceeds to 822 where the system enters standby.

At 832, stored thermal energy is released/dumped from the LAES external high temperature storage unit to enable the system to continue storing thermal energy at 828.

Method 800 can be repeated in whole or in part to provide for continuous storage of thermal energy and/or electric power, an example of which is provided by 834.

In one or more embodiments of the disclosed subject matter, non-transitory computer-readable storage media and a computer processing systems can be provided. In one or more embodiments of the disclosed subject matter, non-transitory computer-readable storage media can be embodied with a sequence of programmed instructions for controlling asymmetric energy storage systems and discharging, charging, and/or dumping therein, the sequence of programmed instructions embodied on the computer-readable storage medium causing the computer processing systems to perform one or more of the disclosed methods.

It will be appreciated that the modules, processes, systems, and devices described above can be implemented in hardware, hardware programmed by software, software instruction stored on a non-transitory computer readable medium or a combination of the above. For example, a method for controlling asymmetric energy storage systems and discharging, charging, and/or dumping therein can be implemented, for example, using a processor configured to execute a sequence of programmed instructions stored on a non-transitory computer readable medium. For example, the processor can include, but is not limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and devices can be implemented as a single processor or as a distributed processor. Further, it should be appreciated that the steps mentioned herein may be performed on a single or distributed processor (single and/or multi-core). Also, the processes, modules, and sub-modules described in the various figures of and for embodiments herein may be distributed across multiple computers or systems or may be co-located in a single processor or system. Exemplary structural embodiment alternatives suitable for implementing the modules, sections, systems, means, or processes described herein are provided below.

The modules, processes, systems, and devices described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the methods, processes, modules, devices, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (software program stored on a non-transitory computer readable medium).

Furthermore, embodiments of the disclosed methods, processes, modules, devices, systems, and computer program product may be readily implemented, fully or partially, in software using, for example, object or object-oriented software development environments that provide portable source code that can be used on a variety of computer platforms. Alternatively, embodiments of the disclosed methods, processes, modules, devices, systems, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the methods, processes, modules, devices, systems, and computer program product can be implemented in hardware and/or software using any known or later developed systems or structures, devices and/or software by those of ordinary skill in the applicable art from the function description provided herein and with a general basic knowledge of electricity generation, electricity storage systems, and/or computer programming arts.

Features of the disclosed embodiments may be combined, rearranged, omitted, etc., within the scope of the invention to produce additional embodiments. Furthermore, certain features may sometimes be used to advantage without a corresponding use of other features.

It is thus apparent that there is provided in accordance with the present disclosure, systems, devices, and methods for asymmetric dispatching. Many alternatives, modifications, and variations are enabled by the present disclosure. While specific embodiments have been shown and described in detail to illustrate the application of the principles of the present invention, it will be understood that the invention may be embodied otherwise without departing from such principles. Accordingly, Applicants intend to embrace all such alternatives, modifications, equivalents, and variations that are within the spirit and scope of the present invention.

1. An energy storage facility comprising:
an energy storage device; and
a renewable energy generating device,
wherein the energy storage device is operable in a few modes of operation, consisting of at least a charging cycle and a discharging cycle,
wherein, during a first period of the charging cycle, energy is consumed by and stored within the energy storage device,
wherein, during a second period of the discharging cycle, energy from the storage device is dispatched to an electrical grid,
wherein the total amount of energy consumed by the storage device is larger than the total amount of energy dispatched from the storage device, and
wherein the total amount of energy dispatched to the electrical grid from both the storage device and the renewable energy generating device does not exceed the total amount of energy drawn down from the grid.

2. The energy storage facility of claim 1,
wherein, during the first period of time of the charging cycle, the storage device consumes electricity and generates liquid air,
wherein the storage device contains at least one thermal energy storage tank or unit,
wherein, during the second period of time of the discharging cycle, the generated liquid air is pumped through at least the one thermal energy storage tank or unit and is vaporized,
wherein the vaporized liquid air is directed to drive a turbine, which in turn drives a generator and generates electricity,
wherein the generated electricity is dispatched to the grid, and wherein the amount of the generated electricity is smaller than the amount of the electricity drawn down from the grid.

3. The energy storage facility of claim 1, wherein the renewable energy generating device is at least one of a Photo Voltage (PV) apparatus, a wind turbine, and/or a concentrated solar thermal apparatus.

4. The energy storage facility of claim 1,
wherein the renewable energy generating device is a Photo Voltage (PV) device,
wherein energy generated by the PV device is directable to at least a first and/or a second recipient,
wherein the first recipient is a power inlet of a motor contained within the energy storage device, and
wherein the second recipient is the electrical grid.

5. The energy storage facility of claim 1,
wherein the energy storage device contains at least a first and a second thermal storage unit,
wherein the first storage unit is a thermal energy storage tank or unit,
wherein the second storage unit is an external thermal energy storage tank or unit,
wherein the second storage unit contains heating coils,
wherein the heating coils charge a suitable storage medium with high temperature thermal energy,
wherein the first storage unit does not contain heating coils, and
wherein the vaporized liquid air is charged with high temperature thermal energy from the external thermal energy storage tank or unit prior to driving the turbine.

6. The energy storage facility of claim 5,
wherein the renewable energy generating device is a Photo Voltage (PV),
wherein energy generated by the PV is directable to at least a first, a second, and/or a third recipient,
wherein the first recipient is a power inlet of a motor contained within the energy storage device,
wherein the second recipient is the electrical grid, and
wherein the third recipient is one or more heating coils located within the external thermal energy storage tank or unit.

7. The energy storage facility of claim 1,
wherein the renewable energy generating device is a wind turbine,
wherein energy generated by the wind turbine is directable to at least a first and/or a second recipient,
wherein the first recipient is a power inlet of a motor contained within the energy storage device, and
wherein the second recipient is the electrical grid.

8. The energy storage facility of claim 5,
wherein the renewable energy generating device is a wind turbine,
wherein energy generated by the wind turbine is directable to at least a first, a second, and/or a third recipient,
wherein the first recipient is a power inlet of a motor contained within the energy storage device,
wherein the second recipient is the electrical grid, and
wherein the third recipient is one or more heating coils located within the external thermal energy storage tank or unit.

9. The energy storage facility of claim 1,
wherein the renewable energy generating device is a concentrated solar thermal,
wherein energy generated by the concentrated solar thermal is directed to one or both of a thermal energy storage and an external thermal energy storage,
wherein the external thermal energy storage contains heating coils, and
wherein the external thermal energy storage does not contain heating coils.

10. A system for augmented energy storage/dispatch, the system comprising:
a Liquid Air Energy Storage (LAES) unit coupled to an electric power consumer and an electric power source to draw down and store excess electric capacity of the electric power source and dispatch stored capacity to the electric power consumer;
the LAES being coupled to and augmented by a low dispatchability electric power source to store electric capacity of the low dispatchability electric power source;
the LAES being coupled to and augmented by a low dispatchability thermal energy source;
a LAES external high temperature storage unit coupled to the low dispatchability electric power source and the electric power source to store electric energy of the low dispatchability electric power source and/or the electric power source as thermal energy;
the LAES external high temperature storage unit coupled to the low dispatchability thermal energy source to store thermal energy from the low dispatchability thermal energy source as thermal enegery; and
the LAES external high temperature storage unit coupled to the LAES to provide stored thermal energy to the LAES during a discharge mode of the LAES to increase the output capacity of the LAES when dispatching energy to the electric power consumer.

11. The system of claim 10, wherein the LAES external high temperature storage unit stores electric energy of the low dispatchability electric power source and/or the electric power source as thermal energy when the LAES cannot store additional energy.

12. The system of claim 10, wherein the low dispatchability electric power source is a Photo Voltage (PV) apparatus, a wind turbine, and/or a concentrated thermal solar apparatus.

13-14. (canceled)

15. The system of claim 10, wherein an electric grid is the electric power consumer and the electric power source.

16. The system of any of claim 10, the system further comprising:
a controller adapted to determine when the LAES cannot store additional capacity and, responsive to the determining, configure the system to convert electric capacity to thermal energy to be stored by the LAES external high temperature storage unit.

17. The system of claim 10, wherein the LAES comprises a turbine, the LAES dispatching capacity by directing high temperature vapor to the turbine, and the LAES external high temperature storage unit increasing the output capacity of the LAES by using the stored thermal energy to further increase the temperature of the vapor being directed to the turbine.

18. A method for augmented energy storage, the method comprising:
detecting excess electric energy on a grid or receiving a request to store excess electric energy on the grid;
configuring, responsive to the detecting or receiving the request, an energy storage system to store the excess electric energy;
storing an amount excess electric energy from the grid;
receiving renewable energy from a renewable energy source;
configuring, responsive to the receiving renewable energy, the energy storage system to store the renewable energy;
storing an amount of renewable energy from the renewable energy source;
dispatching an amount of electric energy to the grid, the stored renewable energy being used to generate a portion of the amount of energy dispatched to the grid and reduce the difference between the amount of excess energy stored from the grid and the amount of electric energy dispatched to the grid.

19. The method of claim 18, wherein the amount of electric energy dispatched to the grid does not exceed the amount of excess energy stored from the grid.

20. The method of claim 18, wherein the configuring, responsive to the detecting or receiving the request, an energy storage system to store the excess electric energy and/or the configuring, responsive to the receiving renewable energy, the energy storage system to store the renewable energy comprises:
determining whether a first energy storage unit is full;
configuring, if the first energy storage unit is not full, the storage system to store the excess electric energy in the first storage unit;
determining, if the first energy storage unit is full, whether a second energy storage unit is full; and
configuring, if the first energy storage unit is full and the second energy storage unit is not full, the storage system to store the excess electric energy in the second storage unit.

21-22. (canceled)

23. The method of claim 20, wherein the first energy storage unit is a LAES and the second energy storage unit is a LAES external high temperature storage unit coupled to the LAES.

24. (canceled)

25. The method of claim 18, wherein the renewable energy source is a Photo Voltage (PV) apparatus, a wind turbine, or a concentrated thermal solar apparatus.
